(19) United States
(12) Patent Application Publication
(10) Pub. No.: US 2014/0124562 A1
(43) Pub. Date: May 8, 2014

(54) WIRE HOLD-DOWN MECHANISM OF NAILING GUN

(71) Applicant: JANN YEI INDUSTRY CO., LTD., Taichung City (TW)

(72) Inventor: Ton-yi CHEN, Taichung City (TW)

(73) Assignee: JANN YEI INDUSTRY CO., LTD., Taichung City (TW)

(21) Appl. No.: 13/798,117

(22) Filed: Mar. 13, 2013

(30) Foreign Application Priority Data
Nov. 5, 2012 (TW) 101140942

(51) Int. Cl. B25C 7/00

(52) U.S. Cl. CPC B25C 7/00
USPC 227/151

(57) ABSTRACT

A wire hold-down mechanism of nailing gun includes a wire hold-down structure arranged in front of a nail striker plate. The wire hold-down structure includes at least a wire hold-down plate located in front of the nail striker plate, a pressing plate arranged above the wire hold-down plate, and an elastic element that biases the wire hold-down plate upward to abut the pressing plate. The wire hold-down plate that is selectively movable upward and downward has an end that forms a wire hold-down notch having an opening facing downward. The pressing plate has a circumference that forms a plurality of pressing edges corresponding to an engagement edge of the wire hold-down plate. The pressing edges are of different distances from center of the pressing plate. As such, the pressing plate that has pressing edges is operable to change the height by which the wire hold-down plate extends out.

### TECHNICAL FIELD OF THE INVENTION

The present invention generally relates to the field of wire holding down of nailing gun, and more particularly to a wire hold-down mechanism of nailing gun that is capable of holding down wires of various gauges and can effectively simplify the structure of nailing gun and improve stability and convenience of operation.

### DESCRIPTION OF THE PRIOR ART

Wires, such as electrical wires, telephone cables, and signal cables, are generally flexible, so that in laying the wires, it is generally impossible to set or fix the wires along a desired route and it is common to fix the wires by wire hold-down nail. The wire hold-down nail is generally composed of a wire hold-down element that has a bottom forming a wire hold-down notch and an inverted U-shaped nail body attached to the wire hold-down element. The wire hold-down notch of the wire hold-down element can be applied to clamp and hold a wire down. To improve the efficient of construction operation, various dedicated nailing devices are currently available in the market. However, since there are a variety of wires of different gauges, in order not to damage the wires but at the same time securely retain the wires in position, the size of wire hold-down nails must be selected according to the wires. This makes it necessary to prepare multiple nailing guns of different specifications. Both operation and stowage are difficult and the expense will be increased.

Taiwan Invention No. 537132 provides a solution, which comprises generally multiple interchangeable protective sheaths. The sheaths have lower ends forming wire hold-down notches of different specifications for working with wires of different gauges. However, the structure is complicated. Further, since there are a variety of protective sheaths used, repeated operation of interchanging the sheaths must be done. This leads to easy loss of the protective sheaths, making interchange inconvenient. Further, Taiwan Utility Model Nos. M297298 and M404756 provide a solution where opposite ends of a wire hold-down plate form first and second receiving insertion plates or first and second positioning edges of different heights, so that a single wire hold-down plate can be applied to wires of different gauges with the two ends thereof.

These solutions are effectively to handle the problem of too many wire hold-down plates that are conventionally used. However, due to taking the height of the wires to be held down into consideration, the wire hold-down notches formed in opposite ends often interfere with each other, making it difficult to achieve a proper design. Further, since the operations that these solutions adopt are simply interchanging the wire hold-down plates and also since they achieve fixing through clamping effected by spring plate, the stability of assembly is generally very limited and the smoothness of operation of striking nails is affected. In addition, it is generally not possible to simplify the components, so that the manufacture cost cannot be lowered. And, they easily suffer loss and inconvenient interchange operation of the wire hold-down plates. Apparently, further improvement is necessary

### SUMMARY OF THE INVENTION

Thus, the primary object of the present invention is to provide a wire hold-down mechanism of nailing gun, which can effectively simplify the structure and requires no interchange of wire hold-down components so that the problem of losing components due to switching among different specifications can be eliminated.

Another object of the present invention is to provide a wire hold-down mechanism of nailing gun, which comprises a wire hold-down component that is secured in a gun body of the nailing gun so as to enhance the convenience of operation.

The present invention adopts the following technical solution to achieve the desired purposes of performance of the present invention. Two mated casing members are provided, having a bottom to which a nail channel is mounted. The nail channel slidably receives therein a nail advancing assembly that drives forward a wire hold-down nail set. The two mated casing members have a front end in which a nail striker plate is slidably arranged in front of the nail channel to selectively strike the wire hold-down nail set. The mated casing members receive therein a wire hold-down structure in front of the nail striker plate.

The wire hold-down structure comprising at least a wire hold-down plate located in front of the nail striker plate, a pressing plate arranged above the wire hold-down plate, and an elastic element that biases the wire hold-down plate upward to abut the pressing plate, wherein the wire hold-down plate is selectively movable upward and downward. The wire hold-down plate has a top forming an engagement edge that the pressing plate abuts and presses. The wire hold-down plate has a lower end that extends outside the casing members and forms a wire hold-down notch that has an opening facing downward.

The pressing plate is rotatably mounted inside the casing members above the wire hold-down plate. The pressing plate has a circumference that forms a plurality of pressing edges corresponding to the engagement edge of the wire hold-down plate. The pressing edges are of different distances from the center of the pressing plate. The pressing plate is operable to selectively set the pressing edges in tight engagement with the engagement edge of the wire hold-down plate.

As such, with the previously described technical solution adopted by the present invention, the nailing gun according to the present invention uses the pressing plate that has a plurality of pressing edges to change the height by which the wire hold-down plate extends outward so as to clamp and hold down wires of different gauges and such an operation can be done by simply rotating the pressing plate. Thus, the present invention is simple in structure and secured in assembly without the concern of parts loss and causing no interference with the operation smoothness of nail striking. The manufacture cost is reduced and added value is thus raised thereby enhancing the economic value.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of a nailing gun according to the present invention, illustrating the structure of the present invention and spatial relationship among components thereof.

FIG. 2 is a perspective view showing a wire hold-down structure of a wire hold-down mechanism of nailing gun according to the present invention.

FIG. 3 is a perspective view showing a portion of the nailing gun according to the present invention.

FIG. 4 is a cross-sectional view showing a portion of the nailing gun according to the present invention.

FIG. 5 is a front view of the nailing gun according to the present invention, illustrating an operation position of the nailing gun.

FIG. 6 is a front view of the nailing gun according to the present invention, illustrating another operation position of the nailing gun.

FIG. 7 is a front view of the nailing gun according to the present invention, illustrating a further operation position of the nailing gun.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

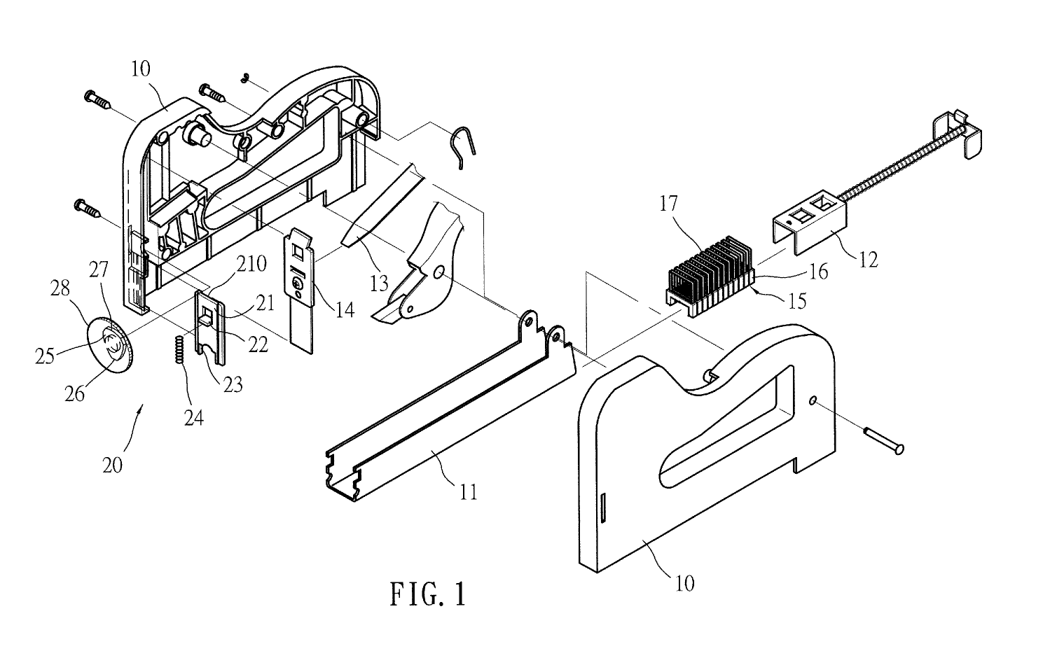

The present invention provides a wire hold-down mechanism of nailing gun, of which the structure is illustrated in FIG. 1. The nailing gun comprises two mated casing members (10) having a bottom to which a nail channel (11) is mounted. The nail channel (11) receives therein a nail advancing assembly (12) that automatically slides forward. The two mated casing members (10) has a front end in which a nail striker plate (14) is slidably arranged in front of the nail channel (11). The nail striker plate (14) is operated to selectively provide powerful downward strikes by a spring plate assembly (13) arranged inside the two mated casing members (10). Further, the nail channel (11) receives therein, in a slidable manner, a wire hold-down nail set (15). The wire hold-down nail set (15) is composed of a series of wire hold-down elements (16) that are lined up and each carries a nail (17). The wire hold-down elements (16) can be used to hold down and retain a wire (30) in position.

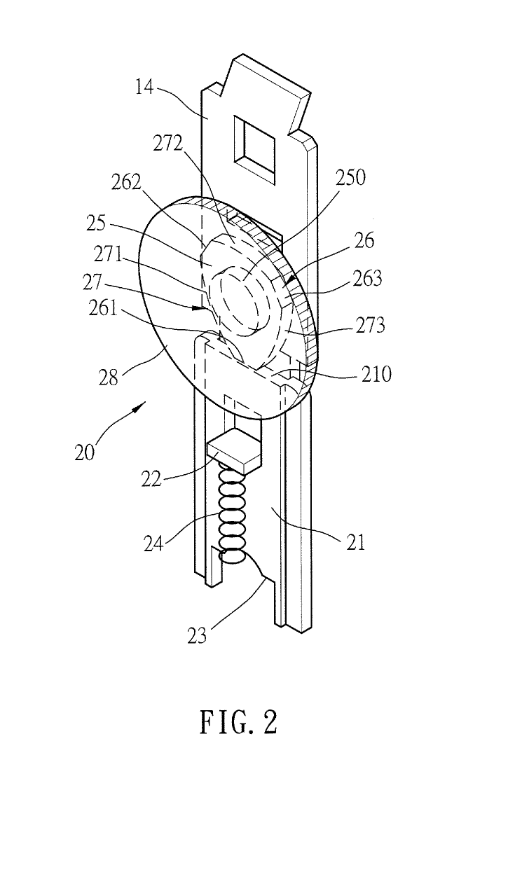

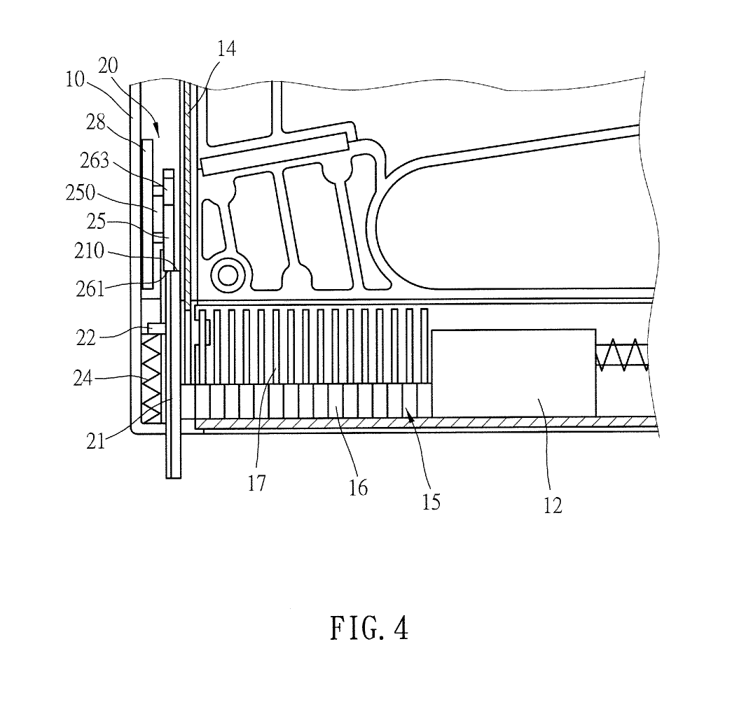

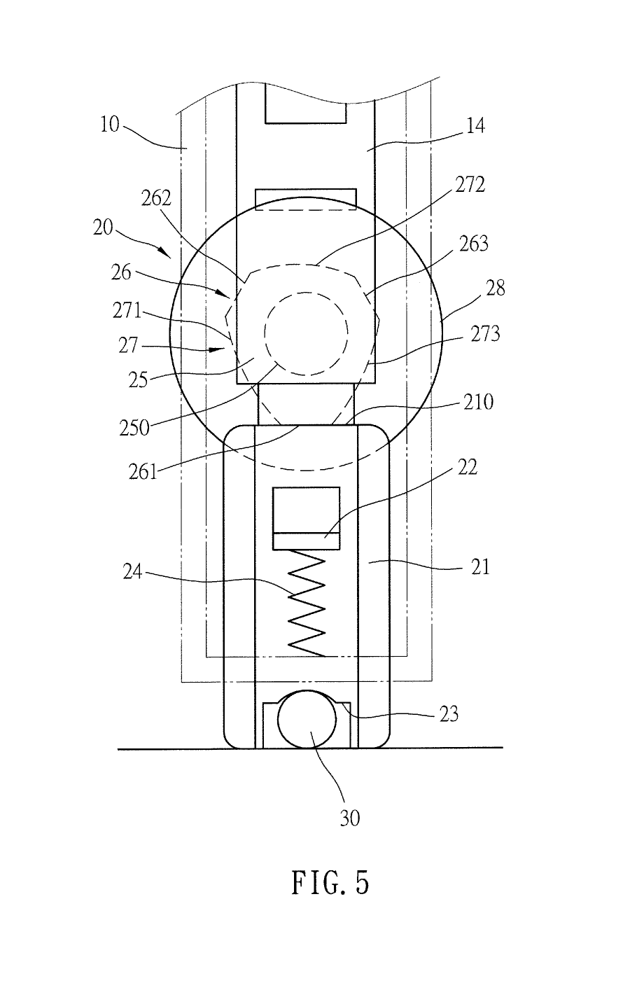

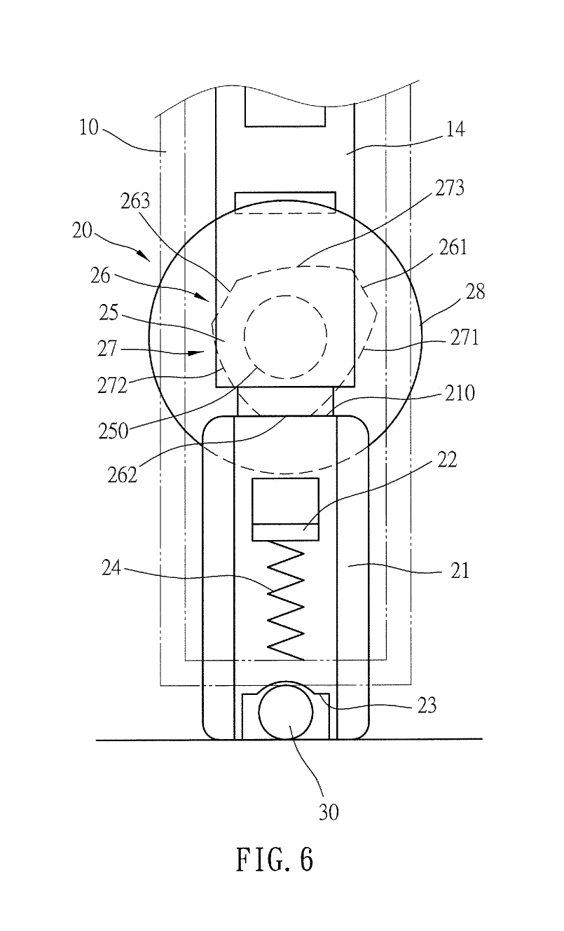

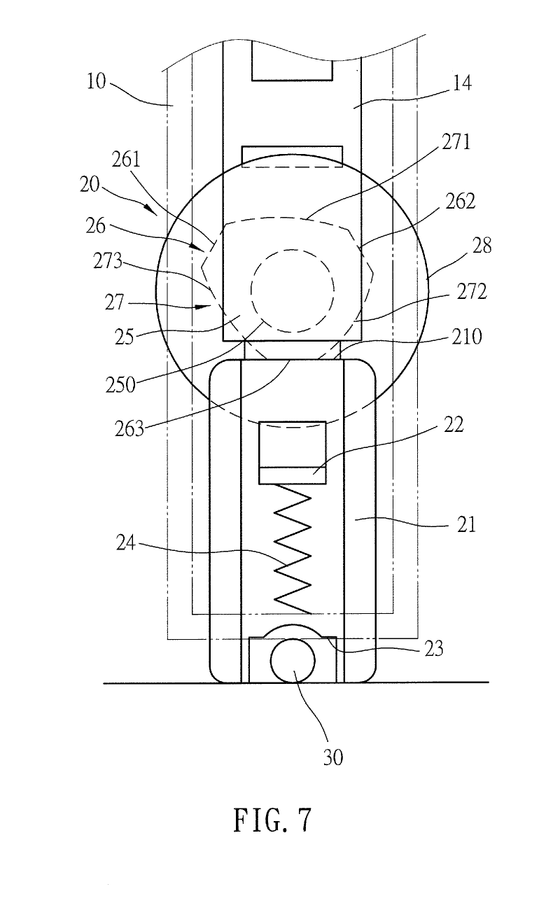

Referring to FIGS. 2, 3, and 4, the feature of the present invention includes a wire hold-down structure (20) that is arranged inside the two mated casing members (10) and located in front of the nail striker plate (14). The wire hold-down structure (20) comprises at least one wire hold-down plate (21), a pressing plate (25) arranged above the wire hold-down plate (21), and an elastic element (24) that biases the wire hold-down plate (21) upward to abut the pressing plate (25). The wire hold-down plate (21) is arranged in front of the nail striker plate (14) and the wire hold-down plate (21) is selectively movable upwards and downwards. The wire hold-down plate (21) has a top forming an engagement edge (210) that the pressing plate (25) abuts and presses. The wire hold-down plate (21) has a middle section on which a protruding tab (22) is formed. The wire hold-down plate (21) has a lower end that extends outside the casing members (10) and forms a wire hold-down notch (23) that has an opening facing downward. The wire hold-down notch (23) functions to receive and hold down a wire (30) that can be of one of a variety of gauges, as shown in FIGS. 5, 6, and 7.

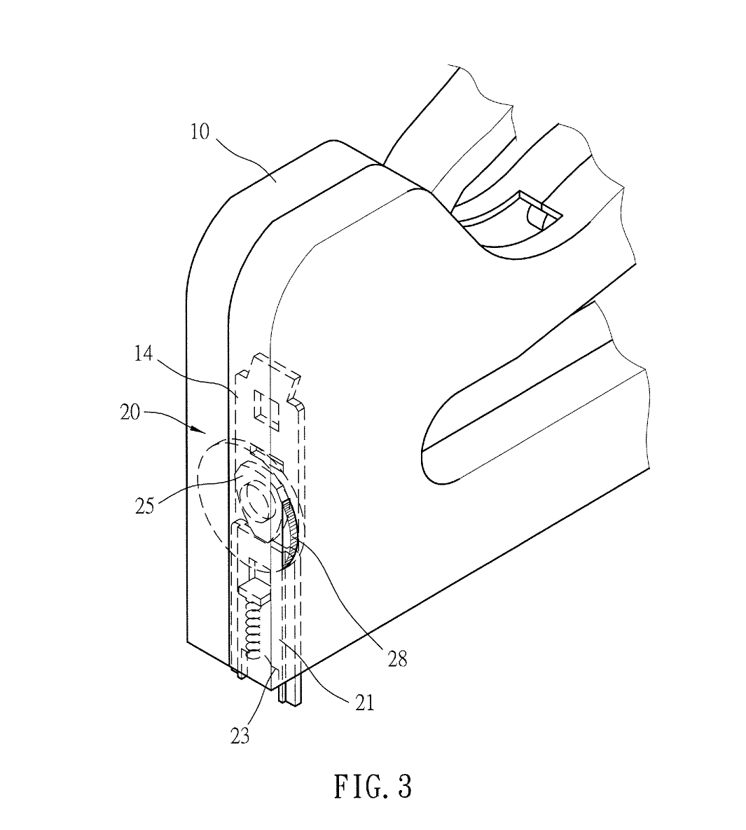

The elastic element (24) can be for example a compression spring. The elastic element (24) is arranged between an underside of the protruding tab (22) of the wire hold-down plate (21) and a bottom of the casing members (10), whereby the wire hold-down plate (21) provides a pre-load that biases the wire hold-down plate (21) upward to set the wire hold-down plate (21) in a tight engagement with the pressing plate (25). Further, the pressing plate (25) is rotatably mounted inside the casing members (10) above the wire hold-down plate (21). The pressing plate (25) has a circumference that forms a plurality of pressing edges (26) corresponding to the engagement edge (210) of the wire hold-down plate (21) and the pressing edges (26) are of different distances from the center of the pressing plate (25). The present invention adopts an arrangement of three pressing edges (26) as a main embodiment thereof and the three pressing edges (26) are respectively defined as the first pressing edge (261), the second pressing edge (262), and the third pressing edge (263), of which the function is to selectively change the “height” by which the wire hold-down plate (21) projects beyond the bottom of the casing members (10), as shown in FIGS. 5-7. Further, the pressing plate (25) comprises a rotation guide edge (27) formed between two adjacent ones of the pressing edges (26). Since the present invention uses three pressing edges (26) as the main embodiment, three spaced rotation guide edges (27) are also taken as the embodiment. These rotation guide edges (27) are respectively defined as the first rotation guide edge (271), the second rotation guide edge (272), and the third rotation guide edge (273) of which the function is to guide the pressing plate (25) to rotate for switching among different pressing edges (26) to press and abut the wire hold-down plate (21). The pressing plate (25) comprises a shaft (250) that projects out from the center of one side of the pressing plate (25). The shaft (250) has a distal end to which a rotary disk (28) is mounted. The rotary disk (28) has a circumference of which at least one portion thereof projects outside a side surface of the casing members (10), as shown in FIG. 3, in order to allow the rotary disk (28) to be operated to drive the pressing plate (25) to rotate, thereby switching the pressing edges (26) that the pressing plate (25) uses to press and abut wire hold-down plate (21).

As such, a wire hold-down mechanism of nailing gun that is simple in structure and easy to operate is provided.

The operation of the present invention will be described with reference to FIGS. 3 and 5-7. A user may directly rotate the portion of the circumference of the rotary disk (28) of the wire hold-down structure (10) that is exposed outside the casing members (10) in order to drive the pressing plate (25) to rotate and thus selectively set the first, second, and third pressing edges (261, 262, 263) to correspond to the engagement edge (210) of the wire hold-down plate (21), thereby changing the height by which the wire hold-down notch (23) of the wire hold-down plate (21) projects outward (as shown in FIGS. 5, 6, and 7). In this way, wires (30) of different gauges can be clamped and held down by the wire hold-down notch (23) that is selectively set at different depths.

It can be understood from the description made above that the nailing gun according to the present invention uses the pressing plate (25) that has a plurality of pressing edges (26) to change the height by which the wire hold-down plate (21) extends outward so as to clamp and hold down wires (30) of different gauges and such an operation can be done by simply rotating the pressing plate (25) without replacing wire hold-down plates as conventionally does. Thus, the present invention is simple in structure and secured in assembly without the concern of parts loss, thereby greatly improving the convenience of operation and causing no interference with the operation smoothness of nail striking. Further, the manufacture cost is reduced and added value is thus raised thereby enhancing the economic value.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A wire hold-down mechanism of nailing gun, which comprises two mated casing members having a bottom to which a nail channel is mounted, the nail channel slidably receiving therein a nail advancing assembly that drives forward a wire hold-down nail set, the two mated casing members having a front end in which a nail striker plate is slidably arranged in front of the nail channel to selectively strike the wire hold-down nail set, the mated casing members receiving therein a wire hold-down structure in front of the nail striker plate;
the wire hold-down structure comprising at least a wire hold-down plate located in front of the nail striker plate, a pressing plate arranged above the wire hold-down plate, and an elastic element that biases the wire hold-down plate upward to abut the pressing plate, wherein the wire hold-down plate is selectively movable upward and downward, the wire hold-down plate having a top forming an engagement edge that the pressing plate abuts and presses, the wire hold-down plate having a lower end that extends outside the casing members and forms a wire hold-down notch that has an opening facing downward; and
the pressing plate being rotatably mounted inside the casing members above the wire hold-down plate, the pressing plate having a circumference that forms a plurality of pressing edges corresponding to the engagement edge of the wire hold-down plate, the pressing edges being of different distances from center of the pressing plate, the pressing plate being operable to selectively set the pressing edges in tight engagement with the engagement edge of the wire hold-down plate.

2. The wire hold-down mechanism of nailing gun according to claim 1, wherein the wire hold-down plate of the wire hold-down structure has a middle section on which a protruding tab is formed, the elastic element being a compression spring and arranged between an underside of the protruding tab of the wire hold-down plate and a bottom of the casing members.

3. The wire hold-down mechanism of nailing gun according to claim 1, wherein the circumference of the pressing plate of the wire hold-down structure forms three pressing edges that are of different distances from the center.

4. The wire hold-down mechanism of nailing gun according to claim 1, wherein the circumference of the pressing plate of the wire hold-down structure comprises a rotation guide edge formed between adjacent ones of the pressing edges.

5. The wire hold-down mechanism of nailing gun according to claim 1, wherein the pressing plate of the wire hold-down structure comprises a shaft that projects out from the center of one side of the pressing plate, the shaft having a distal end to which a rotary disk is mounted, the rotary disk having a circumference of which at least one portion thereof projects outside a side surface of the casing members.
